(19) United States
(12) Patent Application Publication
(10) Pub. No.: US 2012/0237811 A1
(43) Pub. Date: Sep. 20, 2012

(54) LITHIUM ION BATTERY

(75) Inventors: Heng-tao Xia, Dongguan city (CN); Yue-li Wang, Dongguan city (CN); Jian-Jiang Wel, Dongguan city (CN); Xiao-bo Chen, Dongguan city (CN); Zhi-feng He, Dougguan city (CN)

(73) Assignee: DONGGUAN AMPEREX TECHNOLOGY LIMITED, Dongguan city (CN)

(21) Appl. No.: 13/420,709

(22) Filed: Mar. 15, 2012

(30) Foreign Application Priority Data
Mar. 16, 2011 (CN) 201110063335.4

(51) Int. Cl. H01M 4/78; H01M 10/0587

(52) U.S. Cl. 429/94

(57) ABSTRACT

A lithium ion battery includes an anode plate and a cathode plate spirally coiled with a separator set between the anode plate and the cathode plate. The cathode plate includes a cathode current collector and a cathode film on the cathode current collector. The cathode current collector is formed with a number of cathode extending portions along a length direction thereof. The anode plate includes an anode current collector and an anode film on the anode current collector. The anode current collector is formed with a number of anode extending portions along a length direction thereof. After the cathode plate, the anode plate and the separator are coiled as a battery cell, the cathode extending portions are combined to form a cathode lead, and the anode extending portions are combined to form an anode lead. Before manufacture, the compacted cathode plate/anode plate is baked.

### CROSS-REFERENCE TO RELATED APPLICATIONS

The present application claims priority to Chinese Patent Application No. CN 201110063335.4 filed on Mar. 16, 2011, which is incorporated by reference herein in its entirety.

### FIELD OF THE INVENTION

The present application generally relates to lithium ion batteries and, more particularly, relates to a lithium ion battery having desirable heat dissipating performance.

### BACKGROUND OF THE INVENTION

At present, lithium ion battery having low internal resistance and high power generally includes a number of battery cells connected to each other in parallel. Each battery cell includes a stacked electrode group or a coiled electrode group.

The stacked electrode group can remarkably reduce internal resistance of the lithium ion battery. However, it is difficult to accurately register a cathode plate with a corresponding anode plate. Additionally, the heat generated during the work of the battery cell cannot be dissipated efficiently.

As to the coiled electrode group, the anode plate is soldered with a number of anode leads. The cathode plate is soldered with a number of cathode leads. The anode leads are electrically connected to each other in parallel. The cathode leads are also electrically connected one another in parallel. In this manner, internal resistance of the lithium ion battery can be considerably reduced. However, the high power property of the lithium ion battery can hardly meet different requirements in actual use. Additionally, due to strict requirement to the consistency of each battery cell, the manufacturing process is very complex.

To overcome the above mentioned disadvantages, it is proposed that, in the lithium ion battery, the cathode current collector/anode current collector is formed with a number of cathode extending portions/anode extending portions along a length direction thereof. The cathode extending portions/anode extending portions are combined to form a cathode lead/anode lead. When the cathode lead/anode lead is fixed on a cathode post/anode post, most of the points on the cathode plate/anode plate are vertically close to the cathode post/anode post. Therefore, internal resistance of the lithium ion battery can be remarkably reduced and output current of the lithium ion battery is improved. In the work of the lithium ion battery, the cathode current collector and the anode current collector both take part in dissipating heat. Each of the cathode plate and the anode plate is formed as one piece to transfer heat efficiently. Therefore, the heat generated in the lithium ion battery can be dissipated quickly and evenly.

However, in the manufacturing process of the lithium ion battery as described previously, it is difficult to control dislocation of the cathode extending portions/anode extending portions on the cathode current collector/anode current collector. After the cathode plate/anode plate is compacted, thickness of the cathode plate/anode plate will change due to release of stress. Because the thickness change is uniform, it is difficult to accurately position the cathode extending portions/anode extending portions on the cathode plate/anode plate. If the cathode extending portions/anode extending portions are formed before the cathode plate/anode plate experiences a full rebound, and the cathode extending portions/anode extending portions are positioned according to the thickness of the cathode plate/anode plate that has not experienced full rebound, inconformity of the thickness rebound of the cathode plate/anode plate will lead to considerable dislocation of the cathode extending portions/anode extending portions after the battery cell is coiled. On the other hand, if the cathode extending portions/anode extending portions are formed after the cathode plate/anode plate has been stored for a predetermined period of time, the manufacturing productivity will be adversely affected.

Additionally, during the manufacturing process of the battery cell, the cathode plate/anode plate may be damaged when passing through the driving roller, which may adversely affect the character and productivity of the battery manufacturing process.

What is needed, therefore, is to provide a lithium ion battery having desirable heat dissipating performance and desirable extending portion dislocation.

### SUMMARY OF THE INVENTION

Therefore, one objective of the present invention is to provide a lithium ion battery which has desirable extending portion dislocation and desirable heat dissipating performance.

According to one embodiment of the present invention, a lithium ion battery includes an anode plate and a cathode plate spirally coiled with a separator between the anode plate and the cathode plate. The cathode plate includes a cathode current collector and a cathode film containing cathode active material formed on the cathode current collector. The cathode current collector is formed with a number of cathode extending portions along a length direction thereof. The anode plate includes an anode current collector and an anode film containing anode active material formed on the anode current collector. The anode current collector is formed with a number of anode extending portions along a length direction thereof. After the cathode plate, the anode plate and the separator are coiled as battery cell, the cathode extending portions on the cathode current collector are combined to form a cathode lead, and the anode extending portions on the anode current collector are combined to form an anode lead. Before the manufacture of the cathode extending portions/anode extending portions, the cathode plate/anode plate being compacted is baked, so that the thickness of cathode plate/anode plate can rebound evenly and quickly.

Preferably, the cathode plate/anode plate is baked under 110˜150° C. for no less than three minutes.

Preferably, prior to forming the cathode extending portions/anode extending portions on the cathode current collector/anode current collector, thickness of the cathode plate/anode plate is measured at different points on the cathode plate/anode plate to determine an average value of the thickness change of the cathode current collector/anode current collector, and the space between the cathode extending portions/anode extending portions on the cathode current collector/anode current collector is adjusted according to the average value of thickness change of the cathode current collector/anode current collector.

Preferably, each of the cathode extending portions/anode extending portions has an isosceles trapezoid shape, and base angle of the trapezoid is 75˜90 degree.

Preferably, the base angle of the trapezoid is 80˜84 degree.

Preferably, each of the cathode extending portions/anode extending portions has an isosceles trapezoid shape having an arced base angle, and degree of the arc is 75˜90.

Preferably, degree of the arc of the isosceles trapezoid shape having an arced base angle is 80˜84.

Preferably, the cathode lead and the anode lead are seated at same side of the lithium ion battery.

Preferably, the cathode lead and the anode lead are seated at opposite sides of the lithium ion battery.

According to the present invention, the compacted cathode plate/anode plate is baked before the formation of the cathode extending portions/anode extending portions. The compacted cathode plate/anode plate can rebound quickly and evenly, which can reduce dislocation of the cathode extending portions/anode extending portions.

Via measuring thickness of the cathode plate/anode plate at different points on the cathode plate/anode plate, actual dislocation of the cathode extending portions/anode extending portions can be optimized.

Additionally, each of the cathode extending portions/anode extending portions has a isosceles trapezoid shape, which can prevent the cathode extending portions/anode extending portions from being damaged by the driving roller during the manufacturing of the extending portions.

Other advantages and novel features will be drawn from the following detailed description of preferred embodiments with the attached drawings, in which:

### BRIEF DESCRIPTION OF THE DRAWINGS

FIG. 1 depicts an exemplary cross-sectional view of a coiled battery cell in accordance with one embodiment of the present invention;

FIG. 2 depicts an exemplary view of a cathode plate in accordance with one embodiment of the present invention;

FIG. 3 depicts another exemplary view of the cathode plate shown in FIG. 2 from the other side of the cathode plate;

FIG. 4 depicts an exemplary view of an anode plate in accordance with one embodiment of the present invention;

FIG. 5 depicts an exemplary perspective view of a coiled battery cell according to a first embodiment of the present invention;

FIG. 6 depicts an exemplary view of a coiled battery cell according to a second embodiment of the present invention;

FIG. 7 depicts a statistic diagram of lead dislocation of the coiled battery cell according to the first embodiment of the present invention;

FIG. 8 depicts an exemplary view of an extending portion of an lead according to the present invention; and

FIG. 9 depicts another exemplary view of an extending portion of an lead according to the present invention.

### DETAILED DESCRIPTION OF THE INVENTION

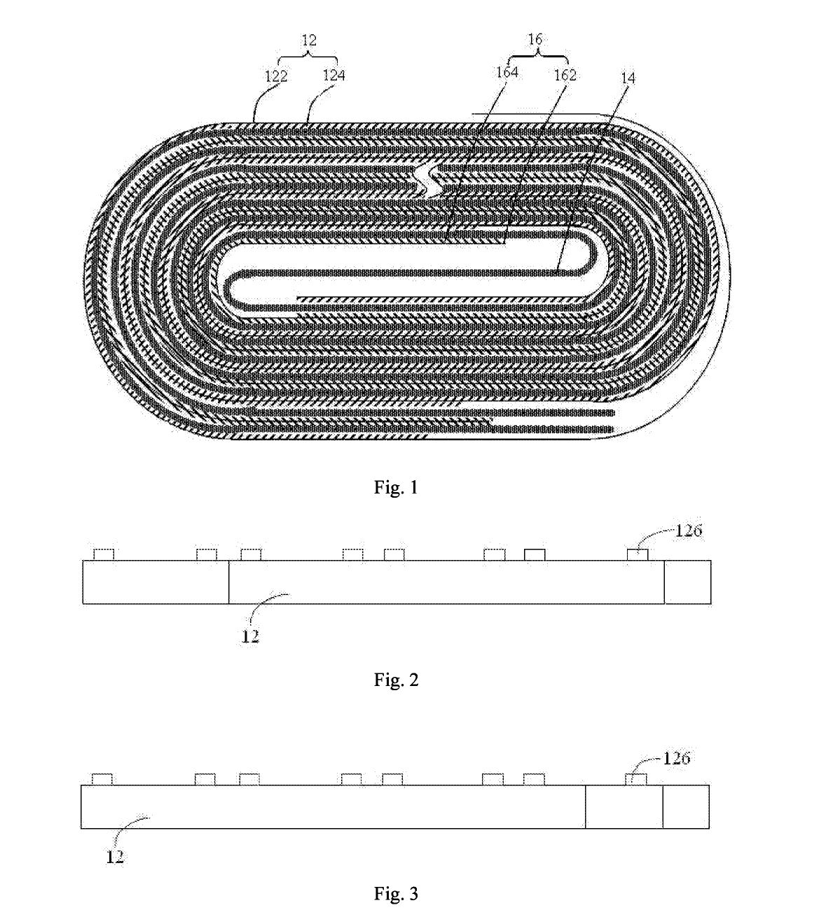

Referring to FIG. 1, a battery cell for use in a lithium ion battery having desirable heat dissipating performance according to one embodiment of the present invention includes a cathode plate 12, a separator 14 and an anode plate 16 spirally coiled. The separator 14 is interposed between the cathode plate 12 and the anode plate 16, so as to insulatively isolate the cathode plate 12 from the anode plate 16 and maintain the electrolyte. The cathode plate 12 includes a cathode current collector 122 and a cathode film 124 having cathode active material formed on the cathode current collector 122. The anode plate 16 includes an anode current collector 162 and an anode film containing anode active material formed on the anode current collector 162. The separator 14 is a microporous membrane obtained via plasticization and extraction process, which can effectively maintain the electrolyte containing lithium salt and organic solvent.

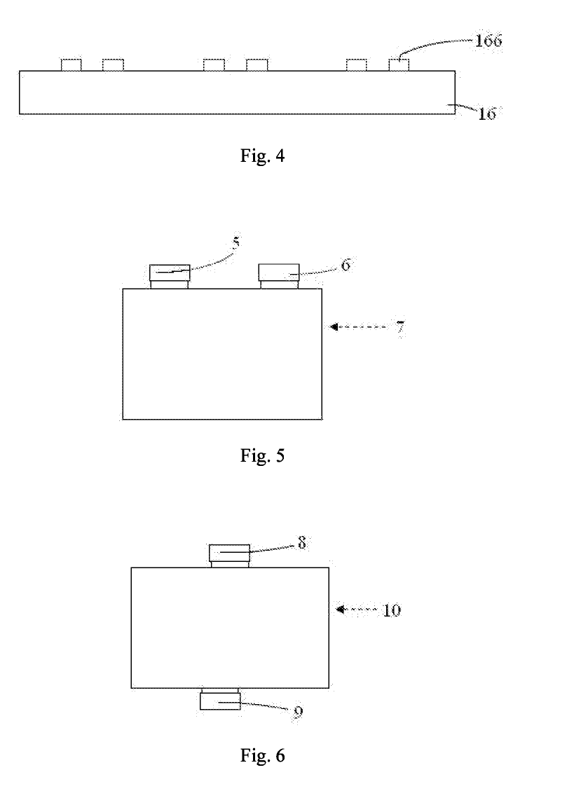

Referring to FIGS. 2 to 4, the cathode plate 12 is provided with a number of cathode extending portions 126 along a length direction thereof. The anode plate 16 is formed with a number of anode extending portions 166 along a length direction thereof.

Referring to FIG. 5, according to a first embodiment of the present invention, after the cathode plate 12, the separator 14 and the anode plate 16 are spirally coiled in a predetermined manner to form a battery cell 7, the cathode extending portions 126 are combined to form a cathode lead 5. The anode extending portions 166 are combined to form an anode lead 6. The battery cell 7 is then electrically connected to external circuits via the cathode lead 5 and the anode lead 6. In the embodiment as illustrated, the cathode lead 5 and the anode lead 6 are situated at same side of the lithium ion battery, i.e. both seated at the upper side of the lithium ion battery.

Referring to FIG. 6, according to a second embodiment of the lithium ion battery of the present invention, a cathode lead 8 and an anode lead 9 are seated at two opposite sides of a battery cell 10, i.e. the cathode lead 8 is seated at upper side of the lithium ion battery while the anode lead 9 is seated at lower side of the lithium ion battery. The cathode plate, the cathode extending portions, the anode plate as well as the anode extending portions of the lithium ion battery according to the second embodiment of the present invention are all the same as those have been detailed in the first embodiment of the present invention and, therefore, will not be described in detail again.

According to the embodiments of the present invention, the cathode current collector 122/anode current collector 162 is formed with a number of cathode extending portions 126/anode extending portions 166 along a length direction thereof. The cathode extending portions 126/anode extending portions 166 are electrically combined to form a cathode lead 5, 8/anode lead 6, 9. When the cathode leads 5, 8 and anode leads 6, 9 are fixed on the cathode post/anode post, most of the points on the cathode plate 12/anode plate 16 are vertically close to the cathode post/anode post. Therefore, internal resistance of the lithium ion battery is reduced and discharge voltage platform and discharge current are remarkably improved. Additionally, charge and discharge temperature of the lithium ion battery is considerably reduced and electrochemical performance of the lithium ion battery is improved, so as to improve output power and further meet the requirement of power batteries or high power batteries.

In the lithium ion battery in accordance with the embodiments of the present invention, the cathode current collector 122 and the anode current collector 162 both take part in dissipating heat. Meanwhile, the cathode current collector 122 and the anode current collector 162 each is integrally formed as one piece to transfer heat efficiently, therefore, heat in the lithium ion battery can be dissipated quickly and evenly.

Referring to FIG. 8, to prevent the cathode extending portion 126/the anode extending portion 166 from being damaged in the manufacturing process, the cathode extending portion 126/anode extending portion 166 each has an isosceles trapezoid shape. Base angle of the isosceles trapezoid is 75 to 90 degree, and preferably 80 to 84 degree.

Referring to FIG. 9, to further protect the cathode extending portion 126/anode extending portion 166, according to another embodiment of the present invention, the isosceles trapezoid shape is disposed to have an arced base angle and degree of the arc is 75 to 90, and preferably 80˜84.

To control dislocation of the cathode extending portions/anode extending portions on the cathode current collector/anode current collector, dislocation of cathode extending portions/anode extending portions of a coiled battery cell is calculated as following.

It is supposed that winding radius of No. 1 circle of the battery cell is r1. After the thickness of the cathode plate/the anode plate changes, the winding radius of the No. 1 circle of the battery cell is R1.

Winding radius of No. 2 circle of the battery cell is r2. After the thickness of the cathode plate/the anode plate changes, the winding radius of the No. 2 circle of the battery cell is R2

Winding radius of No. 3 circle of the battery cell is r3. After the thickness of the cathode plate/the anode plate changes, the winding radius of the No. 3 circle of the battery cell is R3.

. . .

Winding radius of No. n circle of the battery cell is rn. After the thickness of the cathode plate/the anode plate changes, the winding radius of the No. n circle of the battery cell is Rn.

Length of the innermost circle of the battery cell is L0. After thickness of the cathode plate/anode plate changes, length of the innermost circle is L0′, wherein L0′=L0.

Length of the No. 1 circle is L1. After the thickness of the cathode plate/anode plate changes, length of the No. 1 circle is L1′.

Length of the No. 2 circle is L2. After the thickness of the cathode plate/anode plate changes, length of the No. 2 circle is L2′.

Length of the No. 3 circle is L3. After the thickness of the cathode plate/anode plate changes, length of the No. 3 circle is L3′.

. . .

Length of the No. n circle is Ln. After the thickness of the cathode plate/anode plate changes, length of the No. n circle is Ln′.

Therefore, the length of each circle in the battery cell can be calculated as following.

Length of the No. 1 circle L1=2π*r1+2L0, r1=ΔT=Tc+Ta+2Ts, wherein Tc is the thickness of two anode plates, Ta is the thickness of two cathode plates, Ts is the thickness of two separators.

Length of the No. 2 circle L2=2π*r2+2L0 , r2=2ΔT;

Length of the No. 3 circle L3=2π*r3+2L0 , r2=3ΔT;

. . .

Length of the No. n circle Ln=2π*r3+2L0 , rn=nΔT;

When the thickness of the cathode plate/the anode plate changes, assuming the variation is Δt (Δt is the sum of the changes of the cathode plate, the anode plate and the separator.), length of each circle after thickness of the cathode plate/anode plate changes can be calculated as following.

L1′=2π*R1+2L0′, R1=r1+Δt=ΔT+Δt;

L2′=2π*R2+2L0′, R2=R1+ΔT+Δt=r1+ΔT+2Δt=2ΔT+2Δt=r2+2Δt;

L3′=2π*R1+2L0′, R3=R2+ΔT+Δt=r2+2Δt+ΔT+Δt=r3+3Δt;

. . .

Ln′=2π*Rn+2L0′, Rn=R(n−1)+(n−1)Δt+Δt+Δt=rn+nΔt.

In view of the above calculation, difference between actual lead position and standard lead position of each circle can be calculated as following.

The No. 1 circleΔL1=L1′−L1=2π*R1+2L0′−2π*r1−2L0=2π*(R1−r1)=2π*Δt;

The No. 2 circleΔL2=L2′−L2=2π*R2+2L0′−2π*r2−2L0=2π*(R2−r2)=2π*2Δt;

The No. 3 circleΔL3=L3′−L3=2π*R3+2L0′−2π*r3−2L0=2π*(R3−r3)=2π*3Δt;

. . .

The No. n circleΔLn=Ln′−Ln=2π*Rn+2L0′−2π*rn−2L0=2π*(Rn−rn)=2π*nΔt;

Therefore dislocation between the lead on the No. n circle and the lead on the No. 1 circle can be calculated as following.

$$\begin{matrix}total = 2 π * Δ t + 2 π * 2 Δ t + 2 π * 3 Δ t + … + 2 π * n Δ t \\ = 2 π * ( Δ t + 2 Δ t + 3 Δ t + … + n Δ t ) \\ = 2 π * Δ t * ( 1 + n ) * n / 2.\end{matrix}$$

According to the formula, change in thickness of the cathode plate/anode plate and the layer number of the cathode plate/anode plate are two critical factors that determine the dislocation of the extending portions.

On condition that the layer number is same, the smaller the thickness change of the cathode plate/anode plate is, the smaller dislocation of the cathode extending portions/anode extending portions on the cathode lead/anode lead is.

On condition that change in the thickness of the cathode plate/anode plate is the same, the less the layer number is, the smaller dislocation of the cathode extending portions/anode extending portions is.

In view of the above, as long as thickness change of the cathode plate/anode plate and the layer number of the cathode plate/anode plate is controlled, dislocation of the cathode extending portions/anode extending portions can be reduced. Thickness rebound of the cathode plate/anode plate is the critical factor which leads to Δt (the total amount of the changes of the cathode plate, the anode plate and the separator) vary. The present invention is aimed to controlling the thickness rebound of the cathode plate/anode plate, to reduce dislocation of the cathode extending portions/anode extending portions.

To realize quick and even rebound of the thickness of the cathode plate/anode plate, according to one embodiment of the present invention, the cathode plate 12 and the anode plate 16 is baked under 110˜150° C. for no less than three minutes after the cathode plate 12 and the anode plate 16 are compacted and before the cathode extending portions 126 and the anode extending portions 166 are formed.

After quick rebound of thickness of the cathode plate/anode plate is realized, thickness of the cathode plate/anode plate is measured at different points on the cathode plate/anode plate using an automatic thickness measuring equipment, so as to obtain distribution of thickness change and average value of thickness change of the cathode plate/anode plate. The average value of thickness change can be processed via computer to determine positions of the cathode extending portions/anode extending portions and further use manufacturing equipment to form the stacked extending portions which have desirable dislocation. According to the method of the present invention as described, the actual dislocation of the cathode extending portions/anode extending portions can be controlled as less than 6.0 mm, and generally less than 4.0 mm.

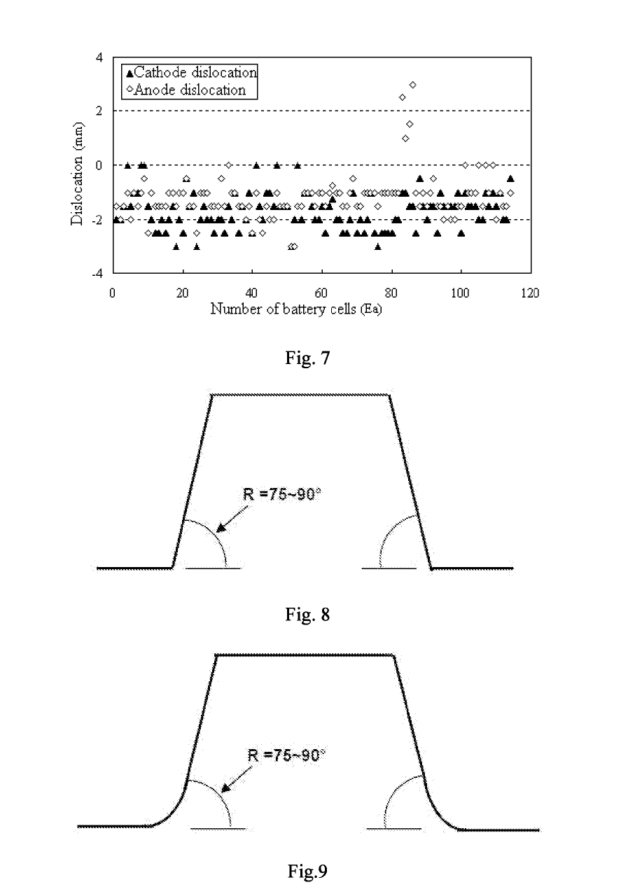

For instance, a lithium ion battery according to the first embodiment of the present invention is illustrated in FIG. 5. The theory capacity of the battery cell is 10 Ah, and the layer number is 22. Li₄Ti₅O₁₂ is used as the cathode active material. The cathode active material, the conductive agent and the bonder are fully stirred to obtain cathode slurry. The cathode slurry is coated on the cathode current collector to form a cathode plate. LiNiCoMnO₂ is used as the anode active material. The anode active material, the conductive agent and the binder is fully stirred to form anode slurry. The anode slurry is coated on the anode current collector to form an anode plate. The separator between the cathode plate and the anode plate is polymer separator of PP or PE. The electrolyte is the mixture of cyclic ester of EC, PC and chain ester of EMC, DEC, DMC. The lithium salt is LiPF₆. The cathode plate/anode plate is baked under 110° C. for three minutes after the cathode plate/anode plate is compacted. Δt is measured as 0.0038 mm via the automatic thickness measuring equipment. According to Δt, dislocation of the cathode extending portions/anode extending portions in each circle can be calculated. For instance, theory maximum extending portion dislocation between the outmost circle (n=22) and the No. 1 circle (n=1) is 6.04 mm. Namely, even if the space between the extending portions is not modified, extending portion dislocation of the battery cell after baking according to the present invention is only about 6.0 mm, which is much less than that of the battery cell not baked. However, for further reducing the extending portion dislocation, dislocation of each extending portion in the battery cell is calculated according to the thickness change Δt measured via automatic thickness measuring equipment. Further, dislocation of each extending portion can be adjusted accordingly, for instance the extending portion on the outmost circle can be adjusted toward the end by 6.04 mm, so that the extending portion dislocation of the battery cell in actual manufacturing process is desirable. According to the statics result of the dislocation as shown in FIG. 7, the average dislocation of the extending portions is less than 4.0 mm.

Due to the arrangement of the cathode extending portions/anode extending portions, the lithium ion battery according to the present invention has desirable power property, cyclic property and security property. The internal resistance of the lithium ion battery in accordance with the present invention is about 3.0 milliohm. Capacity of the battery cell according to the present invention can reach 90% when discharges at 10 C. After 1000 circles under 2 C/2 C 100% SOC, the capacity retention maintains above 80%, which can meet the requirement of high power. The temperature raise is less than 10 degree when circles at 6 C, which indicates that the lithium ion battery has desirable heat dissipating performance.

For instance, the lithium ion battery according to the second embodiment of the present invention is illustrated in FIG. 6. The theory capacity of the battery cell is 3.5 Ah, and the layer number is 26. Li₄Ti₅O₁₂ is used as the cathode active material. The cathode active material, the conductive agent and the bonder are fully stirred to obtain the cathode slurry. The cathode slurry is coated on the cathode current collector to form the cathode plate. LiMn₂O₄ is used as the anode active material. The anode active material, the conductive agent and the binder is fully stirred to form the anode slurry. The anode slurry is coated on the anode current collector to form the anode plate. The separator between the cathode plate and the anode plate is polymer separator of PP, PE. The electrolyte is the mixture of cyclic ester of EC, PC and chain ester of EMC, DEC, DMC. The lithium salt is LiPF₆. The plate is baked under 150° C. for five minutes after the cathode plate/anode plate is compacted. Δt is measured as 0.0027 mm via the automatic thickness measuring equipment. According to Δt, dislocation of the cathode extending portions/anode extending portions in each circle can be calculated. For instance, theory maximum extending portion dislocation between the outmost circle (n=26) and the No. 1 circle (n=1) is 5.95 mm. That is, even if the space between the extending portions is not modified, extending portion dislocation of the battery cell after baking according to the present invention is less than 6.0 mm, which is much less than that of the battery cell not baked. Thereafter, positions of the extending portions and space between the extending portions can be calculated via computer processing, so that the actual extending portion dislocation is even less.

Due to the arrangement of the anode extending portions and the cathode extending portions, the lithium ion battery in accordance with the present invention has desirable power property, cyclic property and security property. The internal resistance of the lithium ion battery is about 1.4 milliohm. The capacity of the battery cell of the present invention can reach 90% when charges at 20 C and reach 95% when discharges at 20 C. After 4000 circles under 5 C/5 C 100% SOC, the capacity retention maintains above 80%. Additionally, in the safety test, there is no noticeable temperature raise in the nail-needle test. The highest overcharge temperature is about 73° C. when overcharges at 1 C/10V. In the thermal case test at 200° C., there is no explosion, smoke and leakage.

While the present invention has been illustrated by the above description of the preferred embodiments thereof, while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and the illustrative examples shown and described.

What is claimed is:

1. A lithium ion battery, comprising:
a cathode plate and an anode plate spirally coiled with a separator set between the cathode plate and the anode plate;
the cathode plate comprising a cathode current collector and a cathode film containing cathode active material formed on the cathode current collector, the cathode current collector being formed with a plurality of cathode extending portions spaced along a length direction thereof, and the cathode extending portions being combined to form a cathode lead;
the anode plate comprising an anode current collector and an anode film containing anode active material formed on the anode current collector, the anode current collector being provided with a plurality of anode extending portions spaced along a length direction thereof, the anode extending portions being combined to form an anode lead; and
wherein before the manufacturing of the cathode plate/anode plate, the cathode plate/anode plate being compacted is baked, so that the thickness of cathode plate/anode plate can rebound evenly and quickly.

2. The lithium ion battery of claim 1, wherein the cathode plate/anode plate is baked under 110˜150° C. for no less than three minutes.

3. The lithium ion battery of claim 2, wherein prior to forming the cathode extending portions/anode extending portions on the cathode current collector/anode current collector, thickness of the cathode plate/anode plate is measured at different points on the cathode plate/anode plate to determine an average value of the thickness change of the cathode current collector/anode current collector, space between the cathode extending portions/anode extending portions on the cathode current collector/anode current collector is adjusted according to the average value of thickness change of the cathode current collector/anode current collector

4. The lithium ion battery of claim 1, wherein each of the cathode extending portions/anode extending portions has an isosceles trapezoid shape, base angle of the trapezoid is 75˜90 degree.

5. The lithium ion battery of claim 4, wherein base angle of the trapezoid is 80˜84 degree.

6. The lithium ion battery of claim 1, wherein each of the cathode extending portions/anode extending portions has an isosceles trapezoid shape having an arced base angle, and degree of the arc is 75˜90.

7. The lithium ion battery of claim 6, wherein degree of the arc of the isosceles trapezoid shape having an arced base angle is 80˜84.

8. The lithium ion battery of claim 1, wherein the cathode lead and the anode lead are seated at same side of the lithium ion battery.

9. The lithium ion battery of claim 1, wherein the cathode lead and the anode lead are seated at two opposite sides of the lithium ion battery.
